(19) United States
(12) Patent Application Publication
(10) Pub. No.: US 2013/0236859 A1
(43) Pub. Date: Sep. 12, 2013

(54) APPARATUS AND SYSTEM FOR APPLYING REMOVEABLE, SHEET MATERIAL ON A WALL

(71) Applicant: Andrea Mayner, Issaquah, WA (US)

(72) Inventor: Andrea Mayner, Issaquah, WA (US)

(21) Appl. No.: 13/771,828

(22) Filed: Feb. 20, 2013

Related U.S. Application Data
(60) Provisional application No. 61/608,179, filed on Mar. 8, 2012.

(51) Int. Cl. B44D 3/00

(52) U.S. Cl. CPC B44D 3/00
USPC 434/84

(57) ABSTRACT

An apparatus and system for applying a removable, sheet material on a substrate. One example embodiment includes an applicator or roller device that is used to apply a temporary, removable sheet of material on walls to preview or sample the color of a ceiling, wall (interior or exterior), or room (or other surfaces) prior to painting a ceiling, wall, or room by placing of sample of paint on the removable sheet.

### CLAIM OF PRIORITY TO FILED APPLICATION

The present application claims priority to U.S. Provisional Application No. 61/608179, filed Mar. 8, 2012, the disclosure of which is hereby incorporated by reference in its entirety.

### FIELD OF THE INVENTION

The invention relates generally to temporary, removable sheet material and system of applying to a substrate on a surface.

### BACKGROUND

Currently there are a number of solutions for previewing color samples on horizontal and vertical surfaces such as interior or exterior walls, floors, and ceilings. One example includes color swatches or color strips that are provided by paint stores that a customer brings home to put up against a wall or other surface to preview a desired color. This approach fails to meet the needs of the consumer and industry because these color samples are small and cannot cover a sufficiently large area to adequately preview the color. Further, due to the inability to sufficiently preview the paint color, the consumer's only choice is to assume the color is acceptable and purchase the expensive custom color they have selected. The consumer ends up absorbing the cost of the paint and wasting time painting when they realize the color is not acceptable (usually when the wall is half painted or a day or two after you have completed the job), Another approach encourages the consumer to apply colored paper to surfaces such as walls or floors, but this approach similarly is unable to meet the needs of the consumer because there is no convenient way for the consumer to generate the colored paper and/or position the paper on the wall or surface to be painted. An example of a pre-decorated strip of self-adhering decorative strips is described in U.S. Pat. No. 4, 900,604 to Martinez et al, the disclosure of which is incorporated by reference in its entirety however it does not provide the consumer with a customizable easy to implement solution to their decorating efforts.

With respect to wallpaper applicators, examples are provided in U.S. Pat. No. 4,261,789 to Spataro and in U.S. Pat. No. 7,540,993 to Dugas et al, both of which are incorporated by reference in their entireties, however they are extremely cumbersome to use and due to their complex designs are too expensive to make for them to be viable consumer products that are only useful for the particular decorating project at hand.

### SUMMARY OF THE INVENTION

In one example embodiment, a temporary, removable sheet material that does not damage the underlying surface provides a means to preview a substrate with different colors before applying a permanent coating such as paint. In another example embodiment, a sheet material is constructed from any suitable material for its use in connection with temporary association with a substrate. In a related embodiment, the substrate is a wall, floor, ceiling or standalone object. In yet another embodiment, the substrate is any horizontal or vertical surface.

In another related embodiment, a roller device or applicator is combined with a roll of removable sheet material to create a substrate applicator system for adhering a removable sheet of paper or other paintable or coatable material to a surface. In this example embodiment, a roller device includes means for supporting a roll of one or more sheets, a longitudinal cutting edge for cutting or tearing the removable sheet material from the roll of sheets and a handle for positioning the rolling device proximate to the surface that will support the removable sheet. In a related embodiment, the roller device supports a continuous roll of sheet material configured to be positioned on a surface. In yet another example embodiment, the roller device or applicator comes in various sizes to support and apply various sizes of removable, semi-permanent or permanent sheet material to be applied to a surface.

In another related embodiment, a kit is provided that includes an applicator and a removable sheet material, such as but not limited to sheets of wallpaper or pre-painted paper (or other material) with an adhesive that allows for easy removal of the paper when the user desires to remove the paper without damaging the underlying wall or surface. In this example embodiment, the kit includes a sizeable portion of a paper sheet applied to a wall so as to create a sufficient preview of the particular color that is being previewed for permanent painting of the underlying wall or surface. In a related embodiment, the kit includes the applicator and the removable sheet material that comprises banners or signage that can be temporarily adhered to walls or other surfaces and then taken down after the event or when desired by user.

In yet another related embodiment, the sheet material of a color previewing kit including an applicator is comprised of sheets that are cut to a desired size and attached to a wall by means of a fastening element, The fastening element includes but is not limited to double sided tape, single sided tape, glazed on glue and a tack which makes the sheet easily removable once the sheet is painted or decorated with a preview color or design. In this example, the sheet material is temporary affixed to the substrate to be painted or coated (or decorated) and the sheet is configured to be easily removed thereafter from the wall or substrate.

In one example embodiment, a system for temporarily sampling coatings on a substrate includes a roll of sheet material adapted to be placed on the substrate and an applicator configured for applying at least a portion of the sheet of material onto the substrate. The applicator includes a longitudinal housing having a holder assembly for receiving the roll of sheet material, the housing having a longitudinal edge spaced from said holder assembly and configured to tear at least a portion of the sheet material that extends away from said housing, wherein a portion of the sheet material is extended from and separated from the applicator and applied to the substrate. In a related embodiment, the applicator further comprises a handle operationally attached to the housing for gripping the applicator and for facilitating application of the portion of the sheet material on the substrate. In yet another related embodiment, the handle is selected from the group consisting of a lateral handle extending perpendicular from the housing, a knob attached to the housing, and a longitudinal slot configured to accommodate a user's hand for gripping the applicator.

The various embodiments of the invention will now be described more fully hereinafter with reference to the accompanying drawings, which are intended to be read in conjunction with both this summary, the detailed description and any number of embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 illustrates perspective view of an example embodiment of an applicator or roller device as taught herein.

FIGS. 2A-2B illustrate side views of an example embodiment of the roller device as taught herein.

FIG. 3 illustrates an angled perspective view of an example embodiment of the applicator as taught herein.

FIG. 4 illustrates an angled inverted view of an example embodiment of the applicator as taught herein.

FIG. 5 illustrates an applicator rolling several sheets of sticky paper onto a wall.

FIG. 6 illustrates several sheets of sheet material applied to a wall and each painted with a different test color.

FIG. 7 illustrates removal of a painted or decorated sheet from a surface or wall.

FIGS. 8A-8C illustrate other embodiments of an applicator for placing sheets of material on a surface.

### DETAILED DESCRIPTION

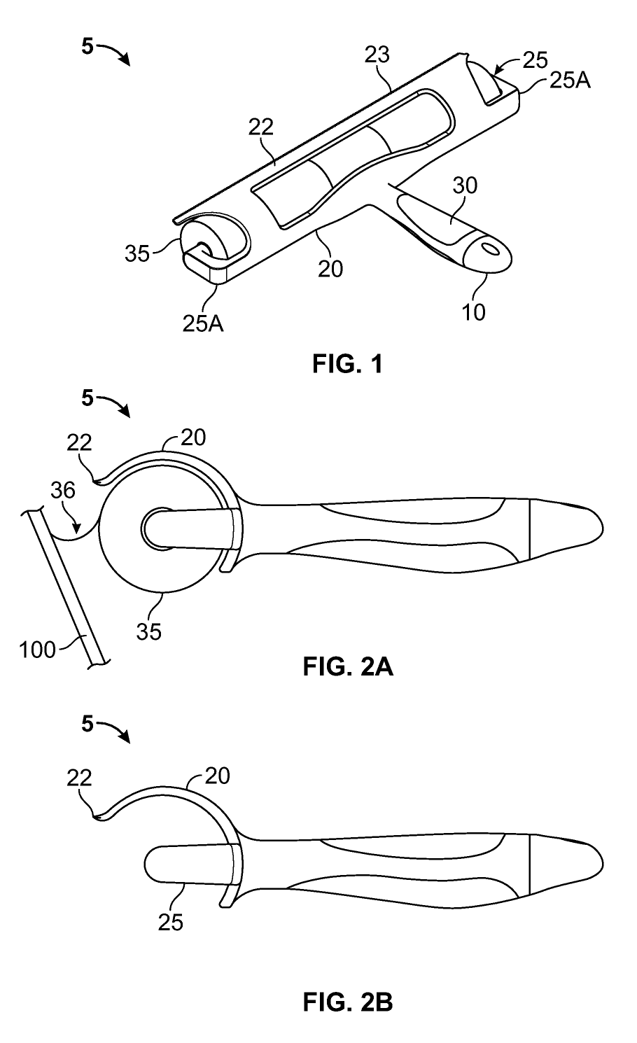

Referring now to the Figures, FIGS. 1-4 illustrate example embodiments of a roller or applicator device 5 with a handle 10 that is configured to support a roll 35 of removable sheet material. An example of a construction of a removable sheet material is described in U.S. application Ser. No. 11/086,159 filed on Mar. 22, 2005, entitled “Temporary Themed Wallpaper Banner and Uses Thereof”(see paragraph 0014), which is herein incorporated by reference in entirety. In this example embodiment, the removable sheet of material, or in this case paper, is configured to include a first surface with an adhesive or tacky material to facilitate mounting on the wall and a second surface opposite the first surface configured to receive paint, a coating, a decoration or the like for purposes of previewing same on a particular wall or surface or other substrate and being able to remove the sheet material easily without damaging the wall, surface or other substrate.

In this example embodiment, roller device 5 includes a handle 10 and a housing 20 that is used to position roller device or applicator 5 having a roll of material 35 supported therein proximate to a substrate or a wall or a surface (not shown). Housing 20 further includes a longitudinal edge 22 with an optional serrated edge surface 23 and a holding assembly 25 for supporting material roll 35. Sheet material roll 35 is supported in housing 20 and allowed to rotate in roller device 5 by the holding assembly 25 comprised of two support members 25A that support roll 35 at each end. In a related embodiment, holding assembly includes a rod to support material roll 35. In other related embodiments, holding assembly 25 includes, but is not limited to, a single support member or an extended portion of housing 20 underneath to hold material roll within the applicator. In this example embodiment, longitudinal edge 22 is positioned and supported by housing 20 and is configured to cut or tear the sheet material from roll 35 when user has achieved the desired sheet size. In this example embodiment, cutting element 23 is corrugated or serrated plastic edge made from the same material as the roller device or includes a separate but attached corrugated/serrated metal cutter to cut the sheet material. In a related embodiment, cutter element 23 is a sharp edge of housing 20 and not necessarily a separate element. In this example embodiment, a handle grip 30 is supported on handle 10 for improved gripping of the applicator during use. A roller device including the support members, cutter, handle, and method are also described in U.S. Pat. No. 7,540,933 issued on Jun. 2, 2009, entitled “Applicator for and Method of Applying a Sheet Material to a Substrate,” which is herein incorporated by reference in its entirety.

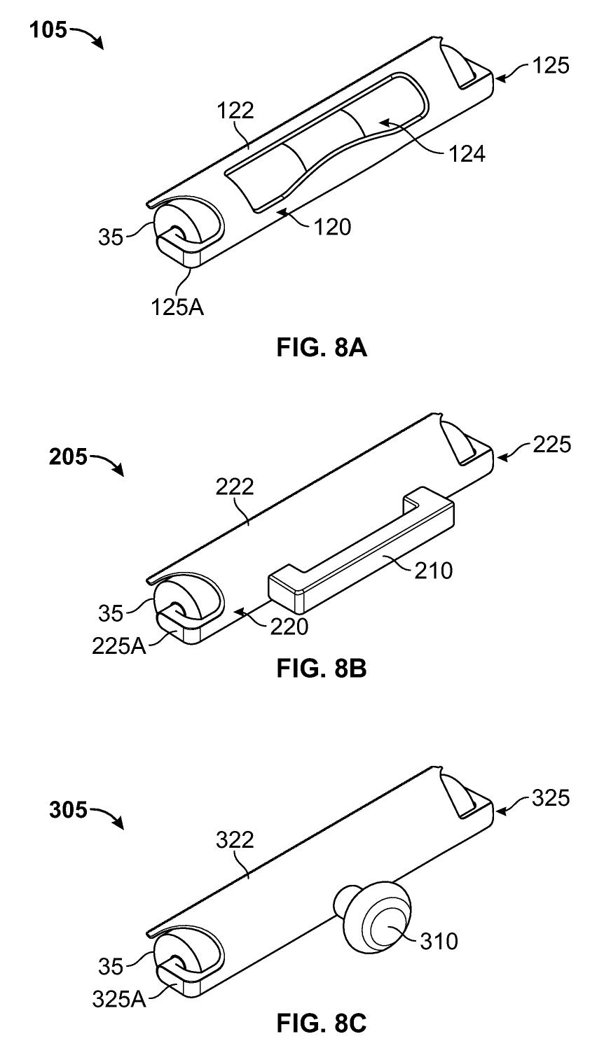

In another related embodiment, roller device 5 includes a removable handle 10 for ease of portability. In yet another related embodiment, handle 10 is eliminated altogether to provide a simple applicator for smaller jobs or smaller rolls of materials (see FIG. 8A). Other handle embodiments are also illustrated in, but not limited to, FIGS. 8B and 8C. In yet another related embodiment, roller device is configured to eliminate housing 20 and includes a cutting bar or element attached to support members 25 or to handle 10.

Referring again to FIGS. 2A-2B, a similar embodiment as in FIG. 1 is illustrated. Roller device 5 is configured to be moved across a substrate surface 100 with sheet roll 35 engaged on substrate surface 100 with a surface of the sheet roll having an adhesive, preferably but not limited to a temporary adhesive to facilitate easy removal. Roll 35 rotates as a sheet 36 adheres to the substrate surface. After a portion of sheet material 36 is applied or adhered to surface 100, cutter or edge 20 is used to separate sheet material 36 from roll 35. FIG. 2B illustrates applicator 5 without a roll 35.

In a related embodiment, the roller device can be sized in various sizes to support and apply various sizes of removable sheet material. In yet another embodiment, the sheet material is wallpaper and an application of a sizeable portion of wallpaper to a wall creates a sufficient preview of the particular color. In yet another embodiment of the invention, the sheet material is perforated or has lines of weakness to allow separation to a predetermined portion. In another example, the sheet material is packaged in pre-perforated sheets (or they can be packaged in rolls) and can be applied to the substrate without the roller device.

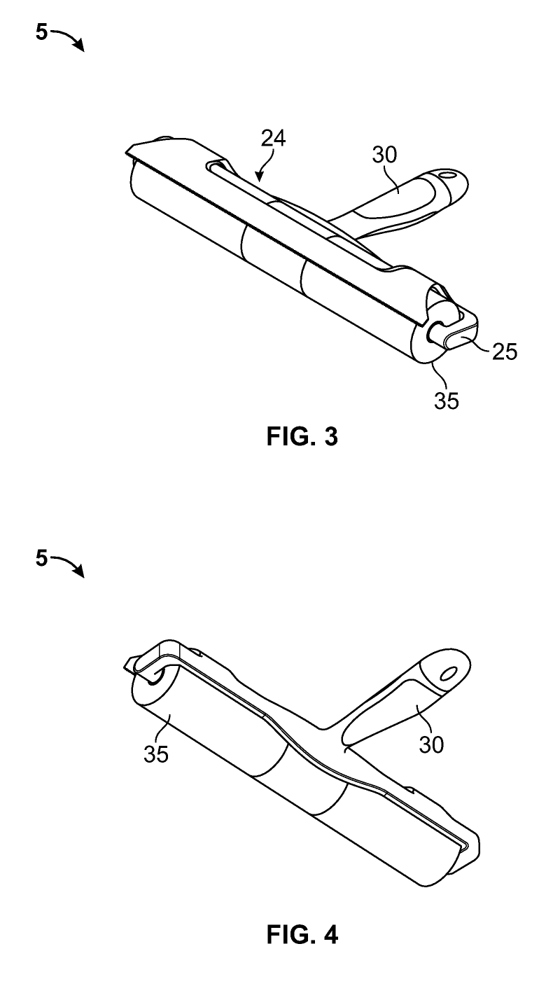

Referring again to FIG. 3-4, a similar embodiment as in FIG. 1 is illustrated. Handle grip 30 is positioned on handle 10 to provide a firmer grip for the user. Handle 10 is used to move roller device 5 along a substrate while roll 15 contacts the substrate. In this example embodiment, housing 20 includes a window 24 for viewing roll 35 to ensure that it is rolling properly. In another embodiment, handle 10 is held while pulling sheet material from roll 15.

In another example embodiment, an adhesive is pre-applied to a sheet material and the adhesive is technologically designed to allow the paper to release from the substrate. In this example embodiment, the adhesive is of the type used by 3M in the Note-it® products or the like. In yet another embodiment, different types of fasteners are used to engage the sheet material to the substrate, such as but not limited to double sided tape, single sided tape, glue stick and a thumbtack.

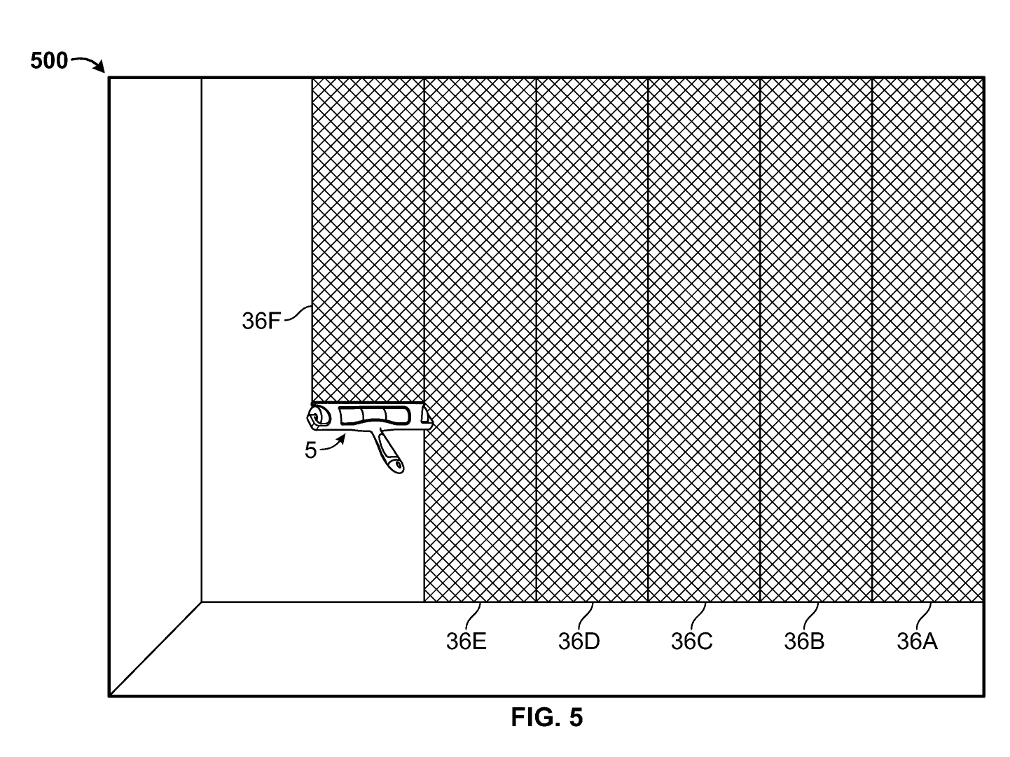

Referring now to FIGS. 5-7, various embodiments of methods of applying removable, temporary sheet material are described: In particular, in other various embodiments of the invention, a method of applying removable, temporary sheet material includes at least one or more of the following steps in various combinations and order: preparing a substrate surface 500 for application of a sheet material or a plurality of sheets 36A-36F from roll 35. An applicator 5 is then provided, as described in various embodiments herein, with roll 35 and then each of sheets 36A-36F having an adhesive thereon (which will easily release from the substrate after use) are applied to wall or surface 500. Applicator 5 is moved across wall 500 so that sheets 36A-36F, or a portion of the sheet material, is released from the roll and engages with wall 500. The released sheet material is then cut or torn with a longitudinal edge of applicator 5 (or may be torn at perforations or lines of weakness).

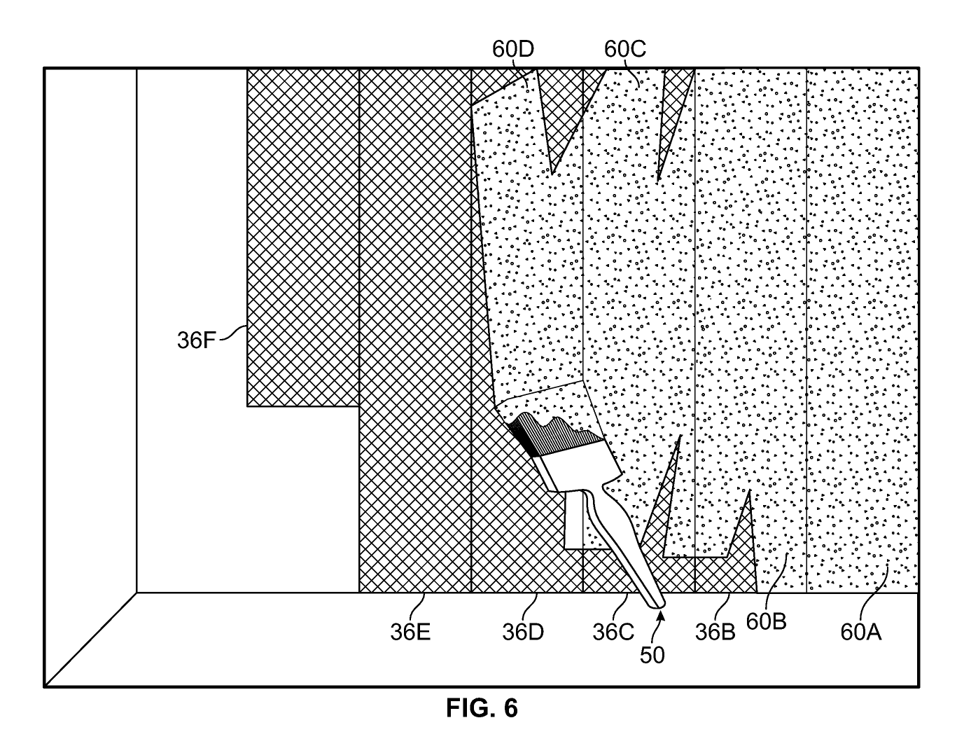

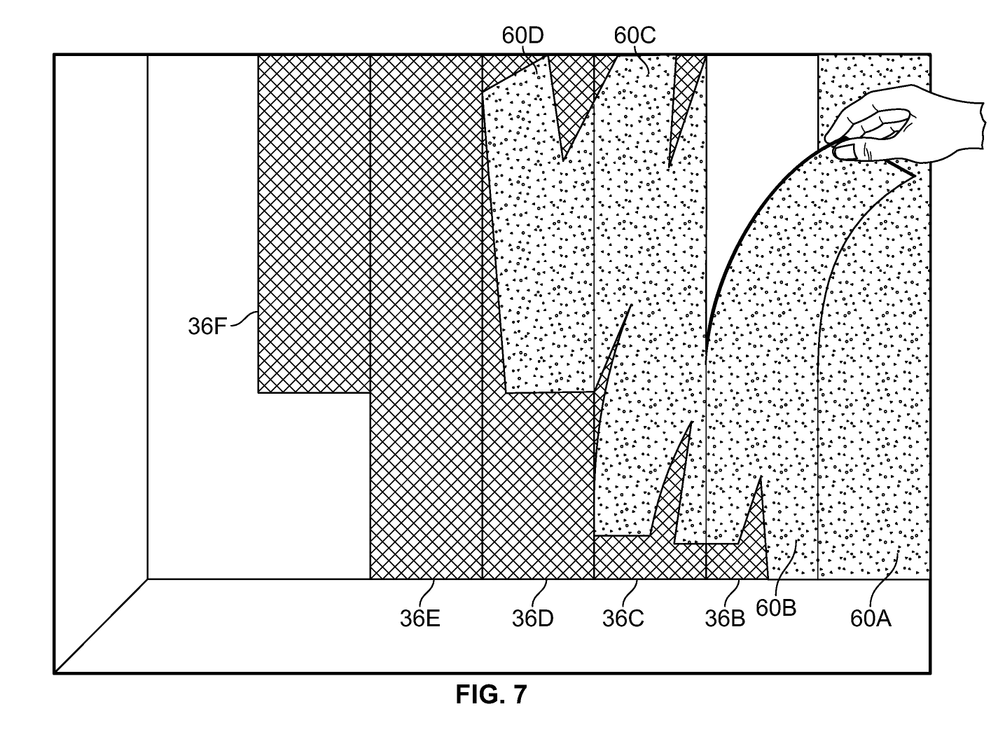

Referring to FIG. 6, a sheet of material 36A is then coated with paint 60A (using a brush 50 or paint roller) or other coating or other decorative material for purposes of previewing the color or decoration. Several colors 60A, 60B, 60C and 60D are previewed on respective sheets 36A, 36B, 36C and 36D. In a related embodiment, the sheet material may be pre-coated with a particular color or decoration. The various sheet materials are then removed from wall 500 when the user is done with the preview, as shown in FIG. 7.

In another embodiment, a sheet material is provided in sheets (or rolls) and without the need for a roller device or applicator. The applicator device is not essential to the use of the removable paper or other sheet material as the method described herein is a step in providing the consumer a method to test paint colors on their interior or exterior walls and ceilings without having to apply paint to the actual surface of the wall or ceiling. The sheet material may provide adhesive strips including double sided tape that are applied to the substrate before applying the sheet material. Optionally, the sheet material may be fastened to the substrate by fasteners or other attachment devices.

In one example embodiment, a method is provided of applying sheets of material for a temporary residence or dwelling to allow for temporary color changes of walls, floors, and ceilings. In another example embodiment, a method is provided of applying sheets of material for horizontal and vertical surfaces (including ceilings or exterior surfaces) to be previewed with a color before a permanent coating is applied. In yet another example, a method is provided of applying sheet material for applying the sheet material to the substrate and then painting it with the desired color. In various example embodiments, the rolls can be either white/neutral in order for the consumer to apply his/her own paint color (or the rolls can be pre-colored by a paint manufacturer).

Referring now to FIGS. 8A-8C, there are illustrated other embodiments of an applicator for placing sheets of material on a surface. In particular, applicator 105 includes a housing 120, a longitudinal edge 122, holding assembly 125 and an optional window 124. In each of the embodiments shown, roll 35 is shown for perspective but is not necessarily a part of the applicator. With respect to applicator 205, it includes a housing 220, a longitudinal edge 222, a slot handle 210 to allow user to grip the applicator or slip the upper hand through with figures first, a holding assembly 225 and an optional window 124. With respect to applicator 305, it includes a housing 320, a longitudinal edge 322, a holding assembly 325 and a knob to allow user to grip the applicator. In a related embodiment, knob 310 is removable when applicator 305 is not in use or not needed. In yet other related embodiments, the applicator includes a leveler unit (unit with liquid and bubble level) on the housing (in place of or with window 124 for instance); one or two guides (protruding pins or plates that touch the wall) located at each end of the housing to assist user in placing sheets of material side by side (as in FIG. 5), vertically or horizontally; and measurement indicators such as inches or metric along the longitudinal edge so that part of the housing can be used as a convenient ruler.

While the various embodiments of invention have been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

I claim:

1. A system for temporarily sampling or previewing coatings on a substrate, the system comprising:
a roll of sheet material adapted to be placed on the substrate; and
an applicator configured for applying at least a portion of the sheet of material onto the substrate, the applicator including a longitudinal housing a holder assembly for receiving the roll of sheet material, said housing having a longitudinal edge spaced from said holder assembly and configured to tear at least a portion of the sheet material that extends away from said housing.

2. The system of claim 1 wherein a portion of the sheet material is extended from and separated from the applicator and applied to the substrate.

3. The system of claim 1 wherein the applicator further comprises a handle operationally attached to said housing for gripping the applicator and for facilitating application of the portion of the sheet material on the substrate.

4. The system of claim 3 wherein the handle is selected from the group consisting of a lateral handle extending perpendicular from the housing, a knob attached to the housing, and a longitudinal slot configured to accommodate a user's hand for gripping the applicator.

5. The system of claim 1 wherein the holding assembly comprises at least one arm configured to hold the roll of sheet material.

6. The system of claim 1 wherein the longitudinal edge comprises a serrated surface.

7. The system of claim 1 wherein a first surface of the sheet material is adapted to receive the coating and wherein a second surface, opposite the first surface, includes a means for attaching the sheet material to the substrate.

8. The system of claim 1 wherein the roll of sheet material is selected from the group consisting of a pre-painted sheet of material, a pre-decorated sheet of material, and a plurality of pre-perforated sheets of material.

9. The system of claim 1 comprises a kit having the roll of sheet material and the applicator.

10. A method of temporarily sampling or previewing coatings on a substrate, the method comprising the steps of:
providing a roll of sheet material adapted to be placed onto the substrate;
providing an applicator configured for receiving the roll of sheet material, the applicator including a longitudinal housing and a holder assembly for receiving the roll of sheet material, the housing having a longitudinal edge spaced from said holder assembly;
applying at least a portion of the sheet of material onto the substrate with the applicator;
separating said portion of sheet material from the roll of sheet using the longitudinal edge of the applicator; and
placing a coating on the separated portion of sheet material.

11. The method of claim 10 wherein the step of placing a coating includes painting a first surface of the portion of the separated sheet material with a desired paint color.

12. The method of claim 11 further comprising the steps of applying a plurality of separated sheet material portions onto the substrate and painting each separated sheet of material with more than one paint color.

13. The method of claim 10 wherein the roll of sheet material includes a plurality of pre-perforated sheets of material with a paintable first surface, said sheets of material having an adhesive on a second surface opposite the first surface.

14. The method of claim 10 wherein applying the sheet of material onto the substrate includes using attachment means, said attachment means selected from the group consisting of double sided tape, a glazed on adhesive, tape, and a thumbtack.

15. An applicator configured for applying a sheet material to a substrate, the applicator comprising:
a longitudinal housing having a holder assembly for receiving the sheet material; said housing having a longitudinal edge spaced from said holder assembly and configured to tear at least a portion of the sheet material, wherein the applicator is adapted to apply and separate a portion of the sheet material when the sheet material is extended from the applicator.

16. The applicator of claim 15 wherein the applicator further comprises a handle operationally attached to said housing for gripping the applicator and for facilitating application of the portion of the sheet material on the substrate.

17. The application of claim 16 wherein the handle is selected from the group consisting of a lateral handle extending perpendicular from the housing, a knob attached to the housing, and a longitudinal slot configured to accommodate a user's hand for gripping the applicator.

18. The applicator of claim 15 wherein said longitudinal edge further includes a serrated surface for tearing or cutting said sheet material.

19. The applicator of claim 15 wherein the holder assembly comprises at least one arm configured to hold the roll of sheet material.

20. The applicator of claim 15 wherein the holder assembly forms part of the housing so as to partially enclose a roll of the sheet material.
